(19) United States
(12) Patent Application Publication
(10) Pub. No.: US 2017/0224586 A1
(43) Pub. Date: Aug. 10, 2017

(54) CONTAINER AND METHOD OF MANUFACTURE OF CONTAINER

(71) Applicant: EULYSIS UK LIMITED, Midlothian (GB)

(72) Inventors: Spyridon Edouard Tsakas, Hudson, MA (US); Spyridon Christos Tsakas, Athens (GR)

(21) Appl. No.: 15/439,722

(22) Filed: Feb. 22, 2017

Related U.S. Application Data
(63) Continuation of application No. 14/119,280, filed on Nov. 21, 2013, now abandoned.

(30) Foreign Application Priority Data
Aug. 22, 2011 (GB) 1114432.6

(51) Int. Cl. A61J 1/20; B65B 3/00; B65B 55/04; B65B 63/08; B65B 7/28; A61J 1/14; B65B 29/10

(52) U.S. Cl. CPC A61J 1/2027; A61J 1/2093; A61J 1/2072; A61J 1/1412; B65B 3/003; B65B 29/10; B65B 63/08; B65B 7/28; B65B 55/04

(57) ABSTRACT

A pre-loaded container and a method of manufacturing a preloaded vial is provided wherein one or more active agents is lyophilized within the vial cap and the vial cap is then sealed onto a vial retaining a suitable diluent to form the pre-loaded vial. Lyophilizing the one or more active agents within the vial cap ensures that the one or more active agents are retained in sterile conditions, that the lyophilized one or more active agents and the diluent may be stored efficiently, and that the one or more active agents may be solubilized in a sterile and efficient manner.

### RELATED APPLICATIONS

The present application is a continuation application of U.S. application Ser. No. 14/119,280, filed Nov. 21, 2013. U.S. application Ser. No. 14/119,280 is a 35 U.S.C. §371 national phase application of PCT/GB2011/052453, filed Dec. 9, 2011. PCT/GB2011/052453 claims the benefit of and priority to UK patent application No. GB1114432.6, filed Aug. 22, 2011. The content of the aforementioned applications are incorporated by reference herein in their entireties.

### FIELD OF THE INVENTION

Methods of manufacturing sterile liquid containers and sterile liquid containers, more specifically methods of manufacturing vials and vials.

### BACKGROUND TO THE INVENTION

In a number of scientific fields, such as medicine and biochemistry, for example, it is common to handle and use biological species in solution. Many of the biological species used are unstable and short lived in solution in vitro without the supporting infrastructure found in vivo, for example. Examples of such biological species include proteins, enzymes, nucleic acid sequences and vaccines. Many species that are unstable in solution have been found to be relatively stable if stored out of solution, that is, if the diluent used in their synthesis or extraction is removed.

One way of doing this is lyophilization, where the sample is frozen and then warmed in vacuum so that the solvent sublimes, leaving the species of interest intact.

Therefore, for administration of a medicament where the one or more active agents is an unstable species in solution, for example, the one or more active agents and the diluent are often stored separately in two sterile storage units before administration.

However, when the one or more active agents and the diluent are stored separately and combined immediately prior to administration, there is a risk of contamination of the medicament. To ensure that contamination does not occur, the combination of the one or more active agents and diluent is carried out using a lengthy and time consuming procedure.

Accordingly, it is one object of the invention to provide a method of preparing active agents and an appropriate diluent for efficient and safe storage.

In addition, the use of two containers and two sets of packaging is wasteful and harmful to the environment, creating twice the waste than that created for active agents stored in a single container.

Accordingly, it is one object of the invention to provide a method of preparing active agents that produces less waste than conventional methods and is therefore more environmentally friendly.

### SUMMARY OF THE INVENTION

According to a first aspect of the invention there is provided a method of manufacturing a pre-loaded container for use in dispensing one or more active agents comprising the steps of;
providing a container, a closure having a recess, and a solution containing one or more active agents;
adding a portion of the solution into the recess of the closure;
lyophilizing the solution in the recess of the closure;
sealing the closure; and
adding a suitable diluent to the container and sealing the container with the closure.

Preferably, the step of sealing the closure comprises sealedly mounting a sealing element comprising a piston.

The piston may comprise a hollow column retained within a cylinder in the closure. The piston may comprise apertures suitable for ventilating the recess of the closure during the step of lyophilization. The step of sealing the closure may seal the apertures of the piston. The piston may comprise a deformable feature extending from the outer surface of the closure such that deformation of the piston by the application of pressure to the said outer surface releases the lyophilized one or more active agents from the closure into the diluent of the container.

Typically, in the prior art lyophilized active agent and diluent are stored in separate sterile containers. Therefore, for anyone active agent to be available for use, two components must be sourced and stored. Generally, when the active agent is to be used, the diluent is extracted from its packaging using a syringe and the syringe is then inserted into the packaging of the active agent. The diluent is then added to solubilize the active agent. The active agent packaging must then be agitated to ensure that the active agent is fully dissolved to reconstitute the active agent into its solubilized form. Finally, the solution is then drawn into the syringe ready for use.

The provision of container made according to the above method allows the active agent and diluent to be stored as a single entity, conserving space. In addition, the process of reconstituting the active agent is greatly reduced to a two-step process of breaking the closure to allow the Lyophilized active agent to fall into the diluent and then agitating the vial to ensure the Lyophilized one or more active agents are fully reconstituted, thereby ensuring that there is no risk of contamination and that the solubilized one or more active agents can be rendered ready for use much faster than convention methods.

Furthermore, the provision of a container storing both the Lyophilized active agent and the diluent required to reconstitute the active agent results in less packaging being required to be manufactured and produces less waste when the container is to be disgarded.

The steps of adding the diluent to the container and sealing the container with the closure may be carried out before or after the steps of adding a portion of the solution into the recess of the closure, lyophilizing the solution in the recess of the closure and sealing the closure.

The container may be a vial. The closure may be a vial cap.

The closure is sterilized before the step of adding the solution to it.

The interior of the container and the interior of the closure are sterile after the container is sealed to the closure.

The provision of a sterilized closure ensures that the one or more active agents are not contaminated before the lyophilization process and therefore that the Lyophilized one or more active agents will be contaminant free. Ensuring that the interior of the container and the interior of the closure are sterile after the container is sealed to the closure allows the user to be confident that the diluent and the Lyophilized one or more active agents are contaminant free and the resultant solubilized one or more active agents are safe to use, especially important in embodiments where the one or more active agents are a vaccine, for example.

The one or more active agents may be a biologically active species, such as artificially expressed or reconstituted proteins, nucleic acid sequences or their mixtures. The one or more active agents may be medically active agents, such as a vaccine, for example.

The diluent is typically an aqueous solution. The diluent may be saline solution, for example.

Therefore, the method of the present aspect of the invention may be used to store proteins expressed in a laboratory or to store the one or more active agents of a medicament for transportation from the manufacturer to the site where it will be administered, for example.

Preferably, immediately preceding the step of lyophilizing the solution in the closure, the closure is covered. The closure may be covered by the sealing element comprising a piston and the piston may define at least one aperture to allow the recess of the closure to be ventilated during the step of lyophilization. The step of sealedly mounting the sealing element to the closure may seal the at least one aperture, thereby sealing the recess of the closure. Alternatively, the closure may be covered by a cover comprising a material that is permeable to the solvent of the active agent solution, such that during Lyophilization the solvent may sublime into the applied vacuum.

The closure may comprise a frangible member. The solution lyophilized within the recess of the closure may be in contact with the frangible member such that the lyophilized one or more active agents is in contact with the frangible member. The piston of the sealing element may be moved from a first position to a second position so that in the second position the piston breaks and extends beyond the frangible member such that the lyophilized one or more active agents is combined with the diluent.

Preferably, the piston of the sealing element is manually operable between the first position and the second position.

According to a second aspect of the invention there is provided a pre-loaded container comprising a container body and a closure; the closure having a recess, a frangible member and a piston arranged adjacent to the frangible member; the container body retaining a diluent and the closure recess retaining one or more active agents lyophilized within the closure by the method of the first aspect of the invention; wherein the piston of the closure may be moved from a first position to a second position so that in the second position the piston breaks and extends beyond the frangible member such that the Lyophilized one or more active agent is combined with the diluent.

The piston may be part of a sealing element sealedly mounted to the closure.

The provision of a pre-loaded container according to the second aspect of the invention allows the one or more active agents that have been Lyophilized within the cap of the vial and the diluent to be stored in the same sterile environment within which mixing and solubilization of the one or more active agents will occur.

Preferably, the piston of the closure is manually operable between the first position and the second position.

The portion of the piston forming an outer surface of the closure may comprise an air tight permeable or semi-permeable material such that a needle may penetrate the outer surface to extract the reconstituted active agent, but ensure that the Lyophilized one or more active agents remain sterile and sealed within the closure.

The piston may move from a first position to a second position such that the piston displaces a floor element of the frangible member of the closure, thereby allowing the lyophilized one or more active agents resting on the said floor element to fall into the diluent in the vial. For example, the floor element may be pivotally mounted to the vial cap such that the movement of the piston results in the floor element being moved from a horizontal orientation to a vertical orientation and the lyophilized one or more active agents falls into the diluent.

Often during the distribution of the Lyophilized one or more active agents in methods of the art the Lyophilized one or more active agents are compressed into a cake or tablet for efficient storage.

The closure recess may retain a cake or tablet of lyophilized active agent such that when the piston is moved from the first position to the second position the cake or tablet of Lyophilized active agent is combined with the diluent.

The cake or tablet of lyophilized active agent may comprise a single active agent. The cake or tablet of lyophilized active agent may comprise more than one active agent.

The cake or tablet of lyophilized active agent may comprise a different active agent to the active agent lyophilized within the closure.

Optional features set out above in respect of the first and second aspects of the invention are optional features of either or both of the first and second aspects.

### DESCRIPTION OF THE DRAWINGS

An example embodiment of the present invention will now be illustrated with reference to the following Figures in which: FIGS. 1a and 1b are side views of a pre-loaded vial (FIG. 1a) as stored and (FIG. 1b) after the one or more active agents have been applied to the diluent; and

FIG. 2 is a scheme of the method of manufacture of a pre-loaded vial.

### DETAILED DESCRIPTION OF AN EXAMPLE EMBODIMENT

With reference to FIGS. 1a and 1b, a pre-loaded vial 1 comprises a vial (acting as a container) 2 and a vial cap 4 (acting as a closure). The vial cap comprises a piston 6, a base 8 (acting as a frangible member) and a recess 10 retaining a lyophilized vaccine 12 (acting as an active agent). The vial retains a diluent 14 (for example, saline solution) suitable for solubilizing the lyophilized vaccine. The piston of the vial cap defines apertures, which are sealed after manufacture.

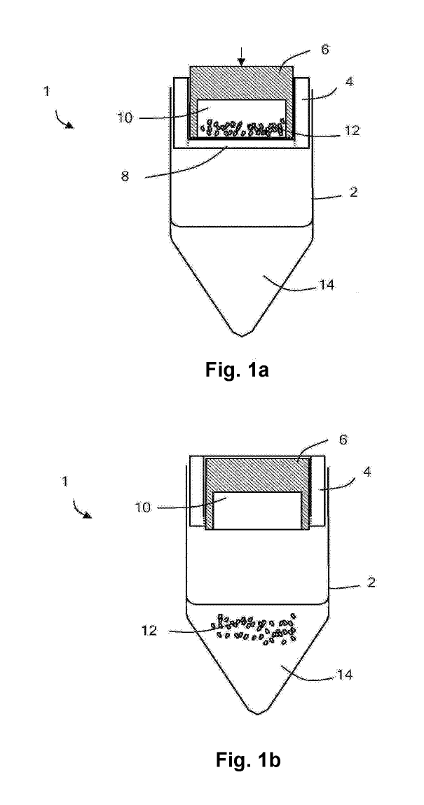

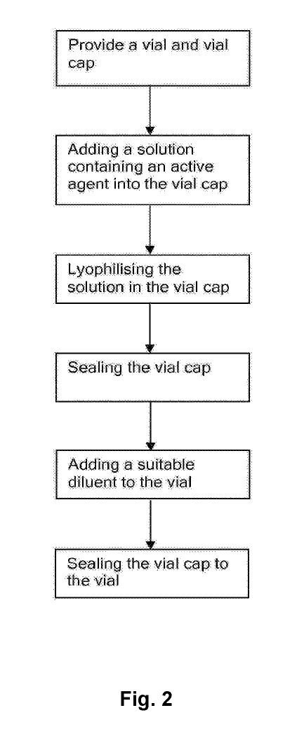

The pre-loaded vial is manufactured by the following method, shown in FIG. 2.

The vial and vial cap are sterilized. A solution of the vaccine is prepared and one dose of the vaccine is placed into the recess of the vial cap. The recess of the vial cap is then covered by the piston. The apertures defined by the piston allow the recess of the vial cap to be ventilated. The vaccine solution within the vial cap is then lyophilized. That is, the vaccine solution is frozen and then warmed in vacuum to allow solvent in the vial cap to sublime into the vacuum through the apertures defined by the piston, leaving the vaccine protein behind in the vial cap. The advantage of lyophilization is that the vaccine protein left behind in the vial cap is not structurally altered and is much more stable than the solubilized vaccine.

The vial cap is then sealed such that the apertures of the piston are sealed and the recess of the vial cap is sealed to ensure that the lyophilized vaccine retained within the recess remains sterile.

The diluent is added to the vial. The vial cap is then sealed to the vial such that the diluent within the vial is sealed from the outside and that the lyophilized vaccine is sealed from the diluent in the vial and the outside, thereby ensuring that the diluent and vaccine are retained in sterile conditions.

A pre-loaded vial prepared by the above method may then be stored within a refrigerator or according to its recommended storage conditions to await use.

With reference to FIGS. 1a and 1b, during use, the piston of the vial cap is pressed by the user (FIG. 1a) such that the piston moves through and extends beyond the base of the vial cap, thereby breaking the said base and allowing the lyophilized vaccine to fall into the diluent within the vial (FIG. 1b). The vial is then agitated to ensure that the vaccine is fully solubilized. The vaccine is then ready for use, and may be extracted by piercing the seal of the piston of the vial cap with a syringe and drawing the newly solubilized vaccine into the syringe after sterilization of the outer surface of the vial cap.

In alternative embodiments, a lyophilized biologic may be stored in the pre-loaded vial using the method of the present invention for storage within a refrigerator or according to its recommended storage conditions.

In further alternative embodiments, the piston may move from a first position to a second position such that the piston displaces the base of the vial, thereby allowing the lyophilized active agent resting on the said base to fall into the diluent in the vial. For example, the base may be hinged such that the base is moved from a horizontal orientation to a vertical orientation such that the lyophilized active agent falls into the diluent.

Further modifications and variations may be made within the scope of the invention herein disclosed.

1. A method of manufacturing a pre-loaded container for use in dispensing one or more active agents, the method comprising
providing a container, a closure having a recess, and a solution containing one or more active agents;
adding a portion of the solution into the recess of the closure;
covering the closure with a sealing element comprising a piston, the piston including an opened end facing the recess of the closure and a closed end opposite the opened end, the piston further including at least one aperture defined by the closed end and extending through the piston to the open end to allow the recess of the closure to be ventilated during lyophilization;
lyophilizing the solution in the recess of the closure;
sealing the closure by sealedly mounting the sealing element to the closure such that the at least one aperture of the piston is sealed, thereby sealing the recess of the closure;
adding a suitable diluent to the container; and
sealing the container with the closure.

2. The method according to claim 1, wherein the container is a vial and the closure is a vial cap.

3. The method according to claim 1, wherein at least one of the one or more active agents is a biologic.

4. The method according to claim 1, wherein at least one of the one or more active agents is a vaccine.

5. The method according to claim 1, wherein the closure is sterilized before the solution is added to the closure.

6. The method according to claim 1, wherein an interior of the container and an interior of the closure are sterile after the container is sealed with the closure.
